(19) United States
(12) Patent Application Publication
(10) Pub. No.: US 2009/0159858 A1
(43) Pub. Date: Jun. 25, 2009

(54) INFRARED SHIELDING FILTER

(75) Inventors: Takafumi Noguchi, Kanagawa (JP); Yujiro Yanai, Kanagawa (JP); Katsuyuki Takada, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/090,211

(22) PCT Filed: Sep. 29, 2006
(86) PCT No.: PCT/JP2006/319575

§ 371 Date: Apr. 14, 2008

(30) Foreign Application Priority Data
Oct. 14, 2005 (JP) 2005-300942

(51) Int. Cl. F21V 9/04

(52) U.S. Cl. 252/587

(57) ABSTRACT

An infrared shielding filter with high heat resistance and transparency realizing an enhanced infrared shielding effect. There is provided an infrared shielding filter comprising, in a dispersion state, microparticles having a negative dielectric constant real part, especially, metal microparticles and/or metal compound microparticles.

### TECHNICAL FIELD

The present invention relates to an infrared shielding filter produced using microparticles.

### BACKGROUND ART

In general, rays having a wavelength of about 380 nm or less are called ultraviolet rays, and rays having a wavelength of about 700 nm or more are called infrared rays. The rays emitted from the sun encompass a broad range of wavelengths from about 200 nm to 5 μm. These rays include rays other than visible rays, such as ultraviolet rays and infrared rays. A large amount of ultraviolet rays and infrared rays are also emitted from a high intensity light source such as a halogen lamp and a metal halide lamp.

Ultraviolet rays tend to induce a suntan, color-fading or deterioration in human bodies and various other objects. On the other hand, infrared rays give rise to heat energy. In general, glass used for window glass cannot completely absorb ultraviolet rays of about 320 nm or more and infrared rays of 5 μm or less. Accordingly, ultraviolet rays and infrared rays easily transmit through such glass. Further, glass and plastics used as a front lens for a lamp or the like cannot cut off ultraviolet rays and infrared rays.

In this regard, a disclosure has been made relating to an ultraviolet and infrared ray cut-off glass having an infrared reflecting layer or an infrared absorbing layer on the surface of an ultraviolet ray cut-off glass on which CuCl and/or CuBr fine particles are deposited (for example, see Patent Document 1).

Further, a disclosure has been made relating to an infrared ray cut-off transparent composition containing, as an infrared absorbing substance, microparticles of a metal oxide selected from the group of metals consisting of indium oxide, tin oxide, ITO, ATO, lanthanum compounds, iron, manganese and the like, at a ratio of 0.01 to 5% by mass with respect to a polyvinyl acetal resin (for example, see Patent Document 2).

### Patent Document 1: Japanese Patent Application Laid-Open (JP-A) No. 7-61835

### Patent Document 2: Japanese Patent Application Laid-Open (JP-A) No. 2005-126650

### DISCLOSURE OF INVENTION

### Problem to be Solved by the Invention

However, the above-described ultraviolet and infrared ray cut-off glasses need to have multiple layers provided to cut off infrared rays and, therefore, there are problems of costs and heat resistance (changes in reflection wavelength caused by a change in layer thickness due to thermal expansion). Further, since the metal oxides in the above are compounds having positive dielectric constant real parts, the infrared ray absorbing capability thereof is insufficient.

The present invention was made in the above circumstances, and provides an infrared shielding filter with an excellent infrared shielding property at low cost. The invention also provides an infrared shielding filter with high heat resistance and transparency.

### Means for Solving Problem

Specific means for solving the above-described problems are described below:

<1> An infrared shielding filter comprising, in a dispersed form, microparticles having a negative dielectric constant real part.

<2> The infrared shielding filter according to <1>, wherein the microparticles are at least one of metal microparticles and metal compound microparticles.

<3> The infrared shielding filter according to <1>, wherein the microparticles are alloy microparticles.

<4> The infrared shielding filter according to <1>, wherein the microparticles are silver microparticles or silver-containing alloy microparticles.

<5> The infrared shielding filter according to <1>, wherein the equivalent spherical diameter of the microparticles is 50 nm or less.

<6> The infrared shielding filter according to <1>, wherein the microparticles are tabular or needle-like microparticles with an aspect ratio of 3 or more.

<7> The infrared shielding filter according to <1>, wherein the filter further comprises a binder and the microparticles are dispersed in the binder.

<8> The infrared shielding filter according to <1>, wherein the microparticles are equilateral triangular or regular hexagonal tabular microparticles.

<9> The infrared shielding filter according to <4>, wherein the microparticles are triangular tabular microparticles with an aspect ratio of from 1.0 to 1.5 or hexagonal tabular microparticles with an aspect ratio of from 4.0 to 7.0.

<10> The infrared shielding filter according to <5>, wherein the equivalent spherical diameter of the microparticles is from 5 to 30 nm.

<11> The infrared shielding filter according to <7>, wherein the dielectric constant of the binder is from 2 to 2.5.

<12> The infrared shielding filter according to <7>, wherein the binder is polyvinyl pyrrolidone.

### EFFECT OF THE INVENTION

The present invention can provide an infrared shielding filter having an excellent infrared shielding property at low cost. Further, the present invention can provide an infrared shielding filter having high heat resistance and transparency.

### BEST MODE FOR CARRYING OUT THE INVENTION

Hereinafter, the infrared shielding filter according to the present invention will be described in detail.

The infrared shielding filter according to the present invention contains, in a dispersed form, microparticles having a negative dielectric constant real part. The infrared shielding filter according to the present invention, for example, can be formed of a layer in which microparticles having a negative dielectric constant real part are dispersed (for example, in the form in which this layer is disposed on a substrate such as a glass substrate). This infrared shielding filter can absorb, cut off, and shield against infrared rays (and ultraviolet rays on occasions) by placing the filter at an arbitrary position in an optical path in a direction of ray emission from an emitter that emits infrared rays (and ultraviolet rays on occasions).

The emission spectrum of the ray emitted from the emitter that emits infrared ray (and ultraviolet rays on occasions) can be detected and measured by using a spectral radiance meter SR-3 (manufactured by TOPCON Co., Ltd.).

—Microparticles having a Negative Dielectric Constant Real Part—

The infrared shielding filter of the present invention contains, in a dispersed form, at least one kind of microparticles having a negative dielectric constant real part (hereinafter, may be referred to as “microparticles of the invention”). The microparticles having a negative dielectric constant real part include metal type microparticles such as metal microparticles, metal compound microparticles and composite particles, and microparticles of a pigment and the like. In the present invention, a high degree of capability of absorbing infrared rays, or a high degree of capability of absorbing infrared and ultraviolet rays, and excellent shielding effects against these rays can be achieved by selecting microparticles having negative dielectric constant real part.

Here, the dielectric constant refers to a physical quantity that indicates the amount of atoms in a substance that respond when an electric field is applied to the substance. In general, the dielectric constant is given by a tensor quantity of a complex number. The real part of a complex dielectric constant is a quantity that represents a tendency for polarization to occur. The imaginary part of the complex dielectric constant is a quantity that represents a degree of a dielectric loss. That is, when the dielectric constant real part is negative, an excellent light absorbing capability can be achieved, and a shielding function can be obtained with a small amount of microparticles. The dielectric constant can be represented by a value obtained by squaring the index of refraction measured by a refractometer, or values of the dielectric constant described in literatures such as “Handbook of Optical Constant” and “Landolt-Boemstein Group 3 Volume 15 Subvolume B”.

Hereinafter, the microparticles of the invention will be described in detail.

(Metal Microparticles)

Metals in the metal microparticles are not specifically limited, and any metals can be used. The metal microparticles include composite particles in which two or more kinds of metals are used in combination. The composite particles can be used as alloy microparticles.

The metals preferably include, as a main component, metals selected from the group consisting of the metals in the fourth period, the fifth period and the sixth period of the long format of periodic table (IUPAC 1991). The metals preferably include metals selected from the group consisting of the metals in the second to the fourteenth groups, and more preferably include, as a main component, metals selected from the group consisting of the metals in the second group, the eighth group, the ninth group, the tenth group, the eleventh group, the twelfth group, the thirteenth group and the fourteenth group. Among these metals, the metals for the microparticles are more preferably the metals in the fourth period, the fifth period and the sixth period, and are still more preferably the metals in the second group, the tenth group, the eleventh group, the twelfth group and the fourteenth group.

Preferable examples of the metal microparticles include at least one selected from copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, and alloys thereof. More preferable metals include at least one selected from copper, silver, gold, platinum, palladium, nickel, tin, cobalt, rhodium, iridium, and alloys thereof, and further more preferable metals include at least one selected from copper, silver, gold, platinum, tin, and alloys thereof. In particular, silver (silver microparticles) is preferable, and as the silver, colloidal silver is most preferable.

(Metal Compound Microparticles)

The “metal compound” is a compound of the above-described metal and an element that is not a metal. Examples of the compounds of the metal and an element that is not a metal include oxides, sulfides, sulfates, carbonates, and the like, of metals, and composite particles containing these compounds. These particles are preferable as the metal compound microparticles.

Examples of the metal compounds include copper oxide (II), iron sulfide, silver sulfide, copper sulfide (II) and titanium black. As the metal compounds, sulfide particles are preferred in view of color tone and easiness of formation of microparticles, and silver sulfide is particularly preferable in view of color tone, easiness of formation of microparticles, and stability.

(Composite Particles)

Composite particles are particles formed by combining a metal and a metal, a metal compound and a metal compound, or a metal and a metal compound, respectively. Examples of these include a particle having different interior and surface compositions, and a particle formed by coalescing two kinds of particles (including alloy). The metal compound and the metal may be a single kind, or two or more kinds, respectively.

Metal microparticles includes composite particles of a metal and another metal. The metal compound microparticles includes composite particles of a metal and a metal compound, and composite particles of a metal compound and another metal compound.

The composite particles are preferably silver-containing alloy microparticles. The “silver-containing alloy microparticles” includes an alloy of silver and another metal, an alloy of silver and a silver compound or a metal compound other than silver, and an alloy of a silver compound and a metal compound other than the silver compound. These may also be used as alloy microparticles.

Specific examples of the composite particles of a metal and a metal compound preferably include composite particles of silver and silver sulfide, and composite particles of silver and copper oxide (II).

(Core-Shell Particles)

The microparticles of the present invention may be core-shell type composite particles (core-shell particles). The core-shell type composite particles (core-shell particles) are particles in which the surface of the core material is coated with a shell material. The shell material for forming the core-shell type composite particles includes, for example, at least one of semiconductors selected from Si, Ge, AlSb, InP, Ga, As, GaP, ZnS, ZnSe, ZnTe, CdS, CdSe, CdTe, PbS, PbSe, PbTe, Se, Te, CuCl, CuBr, CuI, TlCl, TlBr, TII and solid solutions thereof, and solid solutions containing these materials at an amount of 90 mol % or more; or at least one of metals selected from copper, silver, gold, platinum, palladium, nickel, tin, cobalt, rhodium, iridium, iron, ruthenium, osmium, manganese, molybdenum, tungsten, niobium, tantalum, titanium, bismuth, antimony, lead, and alloys thereof. The shell material is also preferably used as a refractive index-adjusting agent for the purpose of reducing reflectivity.

Further, preferable core materials include at least one material selected from copper, silver, gold, palladium, nickel, tin, bismuth, antimony, lead, and alloys thereof.

Methods for producing the composite particles having a core-shell structure are not specifically limited, and representative examples thereof are, for example, as follows:

(1) A method in which a shell of a metal compound is formed on the surface of metal microparticles prepared by known methods by means of oxidation, sulfuration or the like. For example, a method can be mentioned in which metal microparticles are dispersed in a dispersion medium such as water, and a sulfide such as sodium sulfide or ammonium sulfide is added thereto. In this method, the surface of the particles is sulfurized to form core-shell particles. In this case, the metal microparticles to be used can be prepared by known methods such as a vapor phase method and a liquid phase method. For example, a method for producing metal microparticles is described in “Latest Development of Technology of Ultra-fineparticle and Application (II) (SUMIBE TECHNO-RESEARCH CO. (Published in 2002)).

(2) A method in which a shell of a metal compound is continuously formed on the surface of the core in the process of preparing metal microparticles. For example, a reducing agent is added to a metal salt solution to reduce a part of metal ions to form metal microparticles, and then a sulfide is added thereto so that a metal sulfide is formed around the metal microparticles.

The metal microparticles may be commercially available ones. Further, the microparticles can be prepared by a chemical reduction method of metal ions, an electroless plating method, a vaporizing method of metal, or the like. Rod-shaped silver microparticles are formed such that a silver salt is added to spherical silver microparticles serving as seed particles, and a reducing agent with relatively weak reducing force, such as ascorbic acid, is applied thereto in the presence of a surfactant such as CTAB (cetyl trimethylammonium bromide) to form silver rods or wires. This is described in “Advanced Materials 2002, 14, 80-82”. Further, similar descriptions are found in “Materials Chemistry and Physics 2004, 84, 197-204”, and “Advanced Functional Materials 2004, 14, 183-189”.

Further, a method of employing electrolysis is described in “Materials Letters 2001, 49, 91-95”. A method of forming silver rods by irradiating microwaves is described in “Journal of Materials Research 2004, 19, 469-473. An example of combination of reversed micelles and ultrasound is described in “Journal of Physical Chemistry B 2003, 107, 3679-3683”.

With regard to gold, similar descriptions are found in “Journal of Physical Chemistry B 1999, 103, 3073-3077”, “Langmuir 1999, 15, 701-709” and “Journal of American Chemical Society 2002, 124, 14316-14317”.

The formation of rod-shaped particles may be performed by modifying the above-described methods (adjustment of addition amount, pH control).

The metal fine particles in the present invention can be obtained by combining various kinds of particles, in order to impart a color close to achromatic to the particles. By changing the shape of particles from a spherical shape or a cubic shape into a tabular shape (hexagon or triangle) or a rod shape, a higher transmission density can be obtained and a superior shielding property can be attained.

In the above-described metal type microparticles, microparticles having an aspect ratio (ratio of long axial length of particle/short axial length of particle) of 3 or more are preferred, in light of achieving a higher light absorbing effect in the longer wavelength side and an improved infrared shielding effect. In particular, the aspect ratio is preferably from 4 to 80, and is particularly preferably from 10 to 60, since the absorption spectrum can be controlled and superior shielding effect can be attained due to high absorption of infrared rays, or infrared rays and ultraviolet rays.

The aspect ratio means a value obtained by dividing the long axial length by the short axial length of a metal type microparticle, and is a mean value obtained by measuring the values of 100 metal type microparticles. The projection area of the particles can be obtained by measuring the projected area shown in an electron microscopic photograph of the particle, and calibrating the photographing magnification thereof.

Among the above metal type microparticles, hexagonal tabular microparticles, triangular tabular microparticles and rod-shaped metal microparticles are mentioned as preferable ones.

[Hexagonal Tabular Microparticles]

The hexagonal tabular microparticles are those whose tabular shapes are hexagonal. Concrete examples thereof include particles having a tabular shape of, for example, a regular hexagon or a hexagon formed by superposing four congruous isoceles triangles. Among these, preferred are metal type microparticles having a regular hexagonal shape, and particularly preferred are metal microparticles having a regular hexagonal shape.

Here, the “hexagonal shape” refers to a tabular particle shape having six corners, when the particle is regarded as a rectangular parallelepiped having three dimensional diameters of X axis, Y axis and Z axis in the following manner. Namely, when the particle is regarded as a rectangular parallelepiped having three dimensional diameters, the particle having a hexagonal shape is defined as one having a thickness in one axial direction and having six corners within a plane formed by the remaining two axes.

[Triangular Tabular Microparticle]

Triangular tabular microparticles are those whose tabular shapes are triangular. Concrete examples thereof include particles having a shape of an equilateral triangle, rectangular triangle, isosceles triangle and the like. Among these, preferred are metal type microparticles having an equilateral triangular shape, and particularly preferred are metal microparticles having an equilateral triangular shape.

Here, the “triangular shape” refers to a tabular particle shape having three corners when the particle is regarded as a rectangular parallelepiped having three dimensional diameters of X axis, Y axis and Z axis in the following manner. Namely, when the particle is regarded as a rectangular parallelepiped having three dimensional diameters, the particle having a triangular shape is defined as one having a thickness in one axial direction and having three corners within a plane formed by the remaining two axes.

[Rod-Shaped Metal Microparticle]

Rod-shaped metal microparticles are microparticles having a rod shape, and these can provide both of the infrared shielding effect and ultraviolet shielding effect. Specific examples thereof include particles having a needle-like shape, a cylindrical shape, a prismatic shape such as a rectangular parallelepiped, a rugby ball shape, a fibrous shape, or a coil shape in themselves. Among these, the rod-shaped metal microparticles are particularly preferably metal type microparticles having a needle-like shape, cylindrical shape, a prismatic shape such as a rectangular parallelepiped shape, and a rugby ball shape.

Here, the “rod shape” refers to an elongated rod shape when a particle is regarded as a rectangular parallelepiped having three dimensional diameters of X axis, Y axis and Z axis in the following manner. Namely, when the particle is regarded as a rectangular parallelepiped having three dimensional diameters, the particle having a rod shape is defined as one other than the particles having a tabular shape and the particles having a true lateral shape (for example, particles having a true spherical shape, a cube shape or the like in themselves).

As regards the particle size distribution of the rod-shaped metal particles, the width of the particle size distribution of the number average particle diameter, D⁹⁰/D¹⁰, is preferably 1.2 or more and less than 20, where the particle size distribution is approximated to the normal distribution. Here, the particle diameter is expressed as the long axial length L of the particle. D⁹⁰ refers to the particle diameter at which 90% of the particles approximating the average particle diameter are observed. D¹⁰ refers to the particle diameter at which 10% of the particles approximating the average particle diameter are observed. The width of the particle size distribution is preferably 2 or more and 15 or less, more preferably 4 or more and 10 or less, in view of color tone. When the width of the distribution is less than 1.2, the color tone may become close to monochromatic. When the width of the distribution is 20 or more, turbidity may occur due to scattering attributed to coarse particles.

The width of the particle size distribution D⁹⁰/D¹⁰ is measured specifically by: measuring 100 metal microparticles contained in the layer at random according to the below-mentioned method of measuring three dimensional diameters of a particle; determining the long axial length L as the particle diameter and approximating the particle size distribution to the normal distribution; determining the value of the particle diameter D⁹⁰ at which the number of the particles having diameters close to the average diameter is within the range of 90%; and determining the value of D¹⁰ at which the number of particles is within the range of 10% from the average particle diameter. In this way, D⁹⁰/D¹⁰ can be calculated.

(Three Dimensional Diameters)

The metal type microparticle of the present invention is regarded as a rectangular parallelepiped in the following manner and each dimension is measured. That is, a rectangular parallelepipedic box that can fittingly accommodate a metal type microparticle is assumed. The longest axial length L, the thickness t and the width b of this box are defined as the dimensions of the metal type particle. These dimensions satisfy the relationship of L>b≧t, where the larger one of b and t is defined as the width b unless b and t are equal to each other. Specifically, first, a metal particle is placed on a plane such that the metal particle is in a stable and stationary state with the center of gravity being lowest. Next, the metal microparticle is sandwiched between two flat plates that are placed parallel to each other and are vertical to the plane, and the gap between the flat plates is maintained at a position where the gap is minimized. Thereafter, the metal type microparticle is sandwiched between two flat plates that are perpendicular to the aforementioned parallel flat plates defining the gap and are also perpendicular to the plane, and maintain the gap between these plates. Lastly, a top plate is placed on the metal microparticle to be in contact with the highest portion of the microparticle, in parallel with the plane. In this way, a rectangular parallelepiped defined by the plane, two pairs of the flat plates, and the top plate is thus formed. The three dimensional diameters of a microparticle having a coil shape or a loop shape are defined as the values obtained by measuring the microparticle with its shape extended.

*Long Axial Length L

The long axial length L of a rod-shaped metal microparticle or the like is preferably from 10 nm to 1000 nm, more preferably from 10 nm to 800 nm, and most preferably 20 nm to 400 nm (shorter than the wavelengths of visible light). When L is 10 nm or more, there are advantages such that the production process can be simplified, and heat resistance and color hue can be improved. When L is 1000 nm or less, there is an advantage that surface defects can be reduced.

* Ratio of Width b and Thickness t

In rod-shaped metal microparticles or the like, the ratio of width b and thickness t is defined as a mean value of values obtained by measuring 100 rod-shaped metal microparticles. The ratio of width b and thickness t (b/t) of a rod-shaped metal particle is preferably 2.0 or less, more preferably 1.5 or less, and is particularly preferably 1.3 or less. When the ratio b/t exceeds 2.0, the microparticle becomes close to tabular, and heat resistance may be lowered.

* Relationship of Long Axial Length L, Width b and Thickness t

The long axial length L is preferably 1.2 times or more and 100 times or less, more preferably 1.3 times or more and 50 times or less, and particularly preferably 1.4 times or more and 20 times or less, with respect to the width b. When the long axial length L is less than 1.2 times of the width b, characteristics of tabular microparticle will emerge to cause deterioration in heat resistance. When the long axial length L exceeds 100 times of the width b, black density may be lowered and densification in a thin layer may not be achieved.

* Measurement of Length L, Width b and Thickness t

The measurement of the length L, width b and thickness t can be carried out by a surface observation graphic (×500,000) with an electron microscope, and an atomic force microscope (AFM). The length L, width b and thickness t are defined as mean values of values obtained by measuring 100 rod-shaped metal microparticles. The atomic force microscope (AFM) has some operational modes that can be selected according to the purpose. These modes are roughly classified into the following three categories:

(1) Contact method: a method of measuring by bringing a probe into contact with the surface of a specimen to measure the surface configuration on the basis of dislocation of a cantilever;

(2) Tapping method: a method of measuring by bringing a probe into contact with the surface of a specimen in a periodical manner to measure the surface configuration on the basis of variation in vibration amplitude of a cantilever; and

(3) Non-contact method: a method of measuring without bringing a probe into contact with the surface of a specimen to measure the surface configuration on the basis of variation in vibration frequency of a cantilever.

On the other hand, in the aforementioned non-contact method, it is necessary that an extremely weak attraction force is detected with a high sensitivity. Accordingly, a mechanical resonance of the cantilever is utilized, since detection of static force by measuring directly the dislocation of the cantilever is difficult.

The above three methods can be mentioned, and any one of these can be selected according to specimens.

In the present invention, as an electron microscope, the measurement can be carried out at an acceleration voltage of 200 kV using an electron microscope JEM 2010, manufacture by JEOL Ltd. Further, as an atomic force microscope (AFM), SPA-400 manufactured by SEIKO INSTRUMENT CO. can be mentioned. In the measurement with an atomic force microscope (AFM), the measurement can be facilitated by including polystyrene beads for comparison.

The size of the microparticles of the invention is preferably 50 nm or less, and more preferably 30 nm or less in terms of equivalent spherical diameter. The lower limit of the equivalent spherical diameter is 5 nm. When the equivalent spherical diameter is in this range, favorable absorption capability for light having a wavelength in the infrared region (and ultraviolet region) can be achieved, and the shielding effect can be effectively enhanced.

In the present invention, the equivalent spherical diameter is a diameter (2r) calculated from the volume (=(4/3)πr³) obtained from a cross-section and a thickness of a microparticle shown in a photograph taken with an electron microscope. As an electron microscope, an electron microscope JEM 2010, manufacture by JEOL Ltd (for example, measured at an acceleration voltage of 200 kV), and an atomic force microscope (AFM, SPA-400 manufactured by SEIKO INSTRUMENT CO.) can be used.

In the present invention, microparticles having a negative dielectric constant real part are preferably tabular particles or needle-like particles having an aspect ratio of 3 or more. When the microparticles are tabular particles or needle-like particles, transparency and heat resistance can be maintained. Further, when the microparticles are tabular particles or needle-like particles, light absorbance in the infrared region (and ultraviolet region) is high, and in particular, the needle-like particles exhibit an excellent absorption capability in both of the infrared region and ultraviolet region. Therefore, both of the infrared shielding effect and ultraviolet shielding effect can be effectively obtained. In particular, silver particles or silver-containing alloy microparticles are most preferable, and furthermore, silver particles or silver-containing alloy microparticles having a triangular tabular shape with an aspect ratio of from 1.0 to 1.5, or silver particles or silver-containing alloy microparticles having a hexagonal tabular shape with an aspect ratio of from 4.0 to 7.0 are preferable.

(Pigment and Others)

In the present invention, microparticles of a pigment and the like may be used, separately from the aforementioned metal type microparticles, or together with the metal type microparticles. When a pigment is used, a filter having a color hue closer to black can be structured.

As the pigment, carbon black, titanium black or graphite can be preferably mentioned.

Preferable examples of the carbon black include Pigment Black 7 (Carbon Black C.I. No. 77266). As commercially available products, MITSUBISHI CABON BLACK MA 100 (manufactured by MITSUBISHI CHEMICAL CORPORATION) and MITSUBISHI CARBON BLACK # 5 (manufactured by MITSUBISHI CHEMICAL CORPORATION) can be mentioned.

As the titanium black, TiO₂, TiO and mixtures thereof are preferred. As commercially available products, those under the product names of 12S and 13M (manufactured by MITSUBISHI MATERIALS CORPORATION) can be mentioned. The average particle diameter of titanium black is preferably from 40 to 100 nm. The particle diameter of graphite is preferably 3 μm or less in the Stokes diameter.

Known pigments other than the aforementioned pigments may also be used. In general, pigments are broadly classified into organic pigments and inorganic pigments. In the present invention, organic pigments are preferable. Examples of the pigments preferably used include azo pigments, phthalocyanine pigments, anthraquinone pigments, dioxazine pigments, quinacridone pigments, isoindolinone pigments and nitro pigments.

As the concrete examples of microparticles, colored materials recited in Paragraph Nos. [0038]-[0040] of JP-A No. 2005-17716, pigments recited in Paragraph Nos. [0068]-[0072] of JP-A No. 2005-361447, and coloring agents recited in Paragraph Nos. [0080]-[0088] of JP-A No. 2005-17521 may be preferably used.

The pigment can be used as appropriate with reference to those described in “Handbook of Pigments, edited by Japan Pigment Technology Association, SEIBUND-SHINKOSHA, 1989”, and “Colour Index, The Society of Dyes & Colourist, Third Edition, 1987”.

The pigment is preferably one that has a complementary color in relation to the color hue of the rod-shaped metal microparticles. Further, the pigment may be used singly, or in combination of two or more kinds. As the preferable combination of the pigments, a combination of a pigment mixture of a red type and a blue type that are complementary colors to each other and a pigment mixture of a yellow type and a violet type that are complementary colors to each other; a combination in which a black pigment is further added to the aforementioned mixture; and a combination of a blue type pigment, violet type pigment and black type pigment, can be mentioned.

When a pigment is used, the particle diameter (equivalent spherical diameter) thereof is preferably 5 nm or more and 5 μm or less, and is particularly preferably 10 nm or more and 1 μm or less.

—Binder—

In the present invention, a binder may further be used. The aforementioned microparticles (preferably metal type microparticles) are preferably dispersed in the binder. The dispersion state of the microparticles is not specifically limited, but the microparticles are preferably in a stable dispersion state, and more preferably, for example, in a colloidal state.

As the binder, thiol group-containing compounds, amino acids or derivatives thereof, peptide compounds, polysaccharides and natural polymers derived from polysaccharides, synthetic polymers and polymers such as gels derived therefrom, and the like can be mentioned. The binder may be used as a dispersant.

The type of the thiol group-containing compounds is not specifically limited, and any thiol compounds may be used as long as the compounds contain one thiol or two or more thiol groups. As the binders, the thiol group-containing compounds include, for example, alkyl thiols (for example, methyl mercaptan, ethyl mercaptan and the like) and aryl thiols (for example, thiophenol, thionaphthol, benzyl mercaptan and the like). The amino acids and derivatives thereof include, for example, cysteine, glutathione and the like. The peptide compounds include, for example, cysteine residue-containing dipeptide compounds, tripeptide compounds, tetrapeptide compounds, and oligopeptide compounds containing five or more amino acid residues, and the like. Further, proteins (for example, spherical proteins having a metallothioneine or cysteine residue on the surface thereof, and the like) can be mentioned. However, the present invention is not limited thereto.

The above polymers include polymers having protective colloidal properties such as gelatin, polyvinyl alcohol, methyl cellulose, hydroxypropyl cellulose, polyalkylene amines, partially alkyl-esterified polyacrylic acids, polyvinyl pyrrolidone (PVP), polyvinyl pyrrolidone copolymers, and the like. With regard to the polymers that can be used as a dispersant, for example, the descriptions in “Cyclopedia of Pigments” (Edited by Seishiro Ito, Published by ASAKURA PUBLISHING CO., (2000)) can be referred to.

In addition to the above, as the binders, polymers having a carboxyl group at a side chain thereof, such as methacrylic acid copolymers, acrylic acid copolymers, itaconic acid copolymers, crotonic acid copolymers, maleic acid copolymers, partially esterified maleic acid copolymers disclosed in JP-A No. 59-44615, Japanese Patent Publication (JP-B) Nos. 54-34327, 58-12577 and 54-25957, JP-A Nos. 59-53836 and 59-71048 can be mentioned. Cellulose derivatives having a carboxyl group at a side chain thereof can also be mentioned. Furthermore, polymers having a hydroxyl group to which a cyclic acid anhydride is added can also be preferably used. In particular, copolymers of benzyl (meth)acrylate and (meth)acrylic acid, and multicopolymers of benzyl (meth)acrylate, (meth)acrylic acid and nother monomer(s), disclosed in U.S. Pat. No. 4,139,391, can be mentioned.

Among these binders, binders having a dielectric constant in the range of from 2 to 2.5 are preferable in light of stability of a dispersion, and those having a dielectric constant in the range of from 2.1 to 2.4 are particularly preferable. The dielectric constant herein refers to a physical quantity that exhibits the degree of responsiveness of atoms in a material upon application of an electric field to the material.

Further, specific examples of the binders (PO-1 and PO-2) are shown bellow. However, the present invention is not limited thereto.

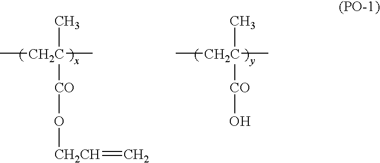

Molecular weight: 38,000; Dielectric constant: 2.22

In the Formula, x:y=80:20 (x and y each represent molar conversion ratio of repeating units.

(PO-2)

Polyvinyl Pyrrolidone Below:

Molecular weight: 40,000; Dielectric constant: 2.34

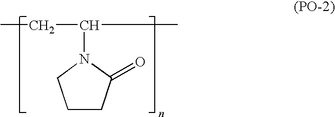

The aforementioned binder is preferably selected from binders having an acid value in the range of from 30 to 400 mgKOH/g and a weight average molecular weight in the range of from 1000 to 300,000.

An alkali soluble polymer other than the above polymers may also be added for the purpose of improving various capabilities such as the strength of cured layer, to such an extent that the alkali soluble polymer does not exert an adverse effect on developability and the like. Examples of these include alcohol-soluble nylons, epoxy resins and the like.

A hydrophilic polymer, surfactant, antiseptic, stabilizer or the like may further be added to a dispersion in which microparticles are dispersed. The hydrophilic polymer may be any polymer as long as it is soluble in water and capable of substantially maintaining a solution state in a diluted condition. For example, proteins or protein-derived substances such as gelatin, collagen, casein, fibronectin, laminin and elastin; natural polymers such as polysaccharides or polysaccharide-derived substances such as cellulose, starch, agarose, carrageenan, dextran, dextrin, chitin, chitosan, pectin, and mannan; synthetic polymers such as poval (polyvinyl alcohol), polyacrylamides, polyacrylic acid polyvinyl pyrrolidone, polyethylene glycol, polystyrene sulfonic acid, and polyallyl amines; or gels derived from these polymers. When gelatin is used, the type of the gelatin is not specifically limited, and for example, cattle bone alkali-treated gelatin, pigskin alkali-treated gelatin, cattle bone acid-treated gelatin, cattle bone phthalated gelatin, pigskin acid-treated gelatin or the like may be used.

As the surfactant, any of anionic, cationic, nonionic and betaine surfactants may be used. Among these, anionic surfactants and nonionic surfactants are particularly preferable. Although a HLB value of the surfactant is not generally determined depending upon whether a solvent for a coating solution is an aqueous type or an organic type, the HLB value is preferably about 8 to 18 for an aqueous type solvent, and is preferably about 3 to 6 for an organic type solvent.

With regard to the HLB value, descriptions in “Surfactant Handbook”, edited by Tokiyuki Yoshida, Shin-ichi Shindo and Kiyoshi Yamanaka, published by KOGAKU TOSHO CO., 1987, can be referred to.

Concrete examples of the surfactants include propylene glycol monostearate, propylene glycol monolaurate, diethylene glycol monostearate, sorbitan monolaurate and polyoxyethylene sorbitan monolaurate. Examples of the surfactants are also described in the abovementioned “Surfactant Handbook”.

The infrared shielding filter of the present invention is suitable for a shielding filter for cutting off infrared rays, or both of the infrared rays and ultraviolet rays, which is provided on an image display portion of an image display device, such as a plasma display device, an EL display device, a CRT display device and a liquid crystal device. Further, the infrared shielding filter is suitable for a shielding filter for cutting off ultraviolet rays provided on a light-emitting face of a device equipped with a light source for emitting ultraviolet rays, such as a light table and a fluorescent lamp such as a backlight for image display (including a cathode ray tube). The liquid crystal display device may be composed of, for example, at least two substrates including a color filter, a liquid crystal provided between the substrates, and two electrodes that apply an electric field to the liquid crystal.

### EXAMPLES

Hereinafter, the present invention is further explained in detail with reference to examples. However, the present invention shall not be construed to limit to the following examples unless the invention exceeds its scope.

### Example 1

### Preparation of Dispersion of Hexagonal Tabular Silver Particles

In accordance with the preparation method of microparticles described in J. Phys. Chem., B 2003, 107, 2466-2470, a dispersion of hexagonal tabular silver particles was prepared. The resultant dispersion of hexagonal tabular silver particles was subjected to centrifugal separation (10,000 r.p.m., for 20 minutes). Thereafter, the supernatant liquid was discarded and the dispersion was concentrated appropriately. Thus, a microparticle dispersion of hexagonal tabular silver particles was obtained.

The aspect ratio R of the obtained hexagonal tabular silver microparticles, as measured according to the aforementioned method in the specification, was 12. The aspect ratio R is the mean value of the measured values of 100 tabular microparticles. The particle diameter of the hexagonal tabular as measured according to the aforementioned method in the specification was 20 nm in terms of equivalent spherical diameter.

Next, 73.5 g of the obtained microparticle dispersion of hexagonal tabular silver microparticles, 1.05 g of the following dispersant PO-2 (polyvinyl pyrrolidone: weight average molecular weight; 40,000, binder dielectric constant; 2.34, the aforementioned exemplary compound), and 16.4 g of methyl ethylketone were mixed. The mixture was dispersed by using an ultrasonic disperser (Tradename: ULTRASONIC GENERATOR MODEL US-6000 ccvp. manufactured by NISSEI CO., LTD.), and a dispersion of hexagonal tabular silver microparticles was obtained.

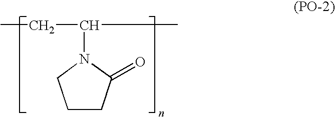

In the preparation of the dispersion of microparticles, silver microparticles having various aspect ratios can be prepared by changing the pH value during reduction of a silver salt, the reaction temperature, and the ratio of a reducing agent to the silver salt.

<Preparation of Filter and Display Device>

Next, the obtained dispersion of hexagonal tabular silver particles was applied onto a glass substrate by a spin coater to a dry thickness of 1.0 μm at 100° C. for 5 minutes, thereby forming an infrared shielding filter. The thus prepared infrared shielding filter was disposed on a liquid crystal display portion of a liquid crystal display device, so as to be positioned in an optical path between an observer and the display portion, and the infrared shielding effect was evaluated as follows.

<Evaluation>

The light emission spectrum from the liquid crystal display device before providing the infrared shielding filter was measured by using a spectral radiance meter SR-3 manufactured by TOPCON Co., Ltd. Subsequently, the emission spectrum from the liquid crystal display device (Manufacturer: SAMSUNG ELECRRONICS Co., Ltd.; Model Sync Master 172X) with the infrared shielding filter disposed on the liquid crystal display portion of the display device was measured via the infrared shielding filter, in a similar manner to the above.

As a result, an absorption of a spectrum in the vicinity of 750 nm was observed, indicating that an infrared shielding effect was obtained. An ultraviolet shielding effect was also obtained. Further, the infrared shielding filter of the present example was able to be manufactured at low cost, and had excellent transparency and heat resistance.

### Example 2

An infrared shielding filter was prepared and evaluated in a similar manner to Example 1, except that the dispersion of hexagonal tabular silver particles was replaced with a dispersion of triangular tabular silver particles prepared by the below-mentioned method.

In a similar manner to Example 1, an absorption of a spectrum in the vicinity of 800 nm was observed, indicating that the infrared shielding effect was obtained. An ultraviolet shielding effect was also obtained. Further, the infrared shielding filter of the present example was able to be manufactured at low cost, and had excellent transparency and heat resistance.

<Preparation of Dispersion of Triangular Tabular Silver Particles>

First, in accordance with the method of preparation of microparticles disclosed in “NANO LETTERS”, 2002 Vol. 2, No. 8, 903-905, a dispersion of triangular tabular silver particles was prepared. The resultant dispersion was subjected to a centrifugal separation (10,000 r.p.m., for 20 minutes). Thereafter, the supernatant liquid was discarded, and the dispersion was concentrated appropriately. Thus, a microparticle dispersion of triangular tabular silver particles was obtained. The aspect ratio R and the equivalent spherical diameter of the obtained triangular tabular silver microparticles, as measured in a similar manner to the above, were 5 and 30 nm, respectively.

Next, 73.5 g of a microparticle dispersion of the obtained triangular tabular microparticles, 1.05 g of the dispersant PO-2 (polyvinyl pyrrolidone: weight average molecular weight; 40,000, binder dielectric constant; 2.34, the aforementioned exemplary compound), and 16.4 g of methyl ethylketone were mixed. The mixture was dispersed by using an ultrasonic disperser (Tradename: Ultrasonic Generator Model US-6000 ccvp, manufactured by NISSEI Co., Ltd.) to obtain a dispersion of triangular tabular silver particles.

In the preparation of the dispersion of microparticles, silver microparticles having various aspect ratios can be prepared by changing the pH value during reduction of a silver salt, the reaction temperature, and the ratio of the reducing agent to the silver salt.

### Example 3

An infrared shielding filter was prepared and evaluated in a similar manner to Example 1, except that the dispersion of hexagonal tabular silver particles was replaced with a dispersion of rod-shaped tabular silver particles prepared by the below-mentioned method.

In a similar manner to Example 1, an absorption of a spectrum in the vicinity of 850 nm was observed, indicating that an infrared shielding effect was obtained. An ultraviolet shielding effect was also obtained. Further, the infrared shielding filter of the present example was able to be manufactured at low cost, and had excellent transparency and heat resistance.

<Preparation of Dispersion of Rod-Shaped Tabular Silver Particles>

First, in accordance with the preparation method of microparticles described in Materials Chemistry and Physics 2004, 84, P197-204, a dispersion of rod-shaped tabular silver particles was prepared. The resultant dispersion of rod-shaped tabular silver particles was subjected to a centrifugal separation (10,000 r.p.m., for 20 minutes). Thereafter, the supernatant liquid was discarded, and the dispersion was concentrated appropriately. Thus, a dispersion of rod-shaped tabular silver particles was obtained.

The long axial length L, width b and thickness t, and the particle size distribution of D⁹⁰/D¹⁰ of the obtained rod-shaped tabular silver particles were measured in the aforementioned method, and the result was that the long axial length L: 100 nm, the width b: 10 nm, and the thickness t: 10 nm. The value of the long axial length L was regulated by adjusting the pH value during reduction of a silver salt, the reaction temperature, and the ratio of the seed particles to the silver salt.

Next, 73.5 g of a microparticle dispersion of the obtained rod-shaped tabular microparticles (long axial length L: 100 nm; width b: 10 nm n; thickness t: 10 nm), 1.05 g of the above dispersant PO-2 (polyvinyl pyrrolidone: weight average molecular weight; 40,000, binder dielectric constant; 2.34, the aforementioned exemplary compound), and 16.4 g of methyl ethylketone were mixed. The mixture was dispersed by using an ultrasonic disperser (Tradename: Ultrasonic Generator Model US-6000 ccvp, manufactured by NISSEI Co., Ltd.), thereby obtaining a dispersion of rod-shaped tabular silver microparticles.

The disclosure of Japanese Patent Application No. 2005-300942 is incorporated herein into this specification as a whole by reference.

All documents, patent applications and technical standards recited in this specification are incorporated herein by reference in this specification to the same extent as if each individual publication, patent application or technical standard was specifically and individually indicated to be incorporated by reference.

1. An infrared shielding filter comprising, in a dispersed state, microparticles having a negative dielectric constant real part.

2. The infrared shielding filter according to claim 1, wherein the microparticles are at least one of metal microparticles and metal compound microparticles.

3. The infrared shielding filter according to claim 1, wherein the microparticles are alloy microparticles.

4. The infrared shielding filter according to claim 1, wherein the microparticles are silver microparticles or silver-containing alloy microparticles.

5. The infrared shielding filter according to claim 1, wherein the equivalent spherical diameter of the microparticles is 50 nm or less.

6. The infrared shielding filter according to claim 1, wherein the microparticles are tabular or needle-like microparticles with an aspect ratio of 3 or more.

7. The infrared shielding filter according to claim 1, wherein the filter further comprises a binder and the microparticles are dispersed in the binder.

8. The infrared shielding filter according to claim 1, wherein the microparticles are equilateral triangular tabular microparticles or regular hexagonal tabular microparticles.

9. The infrared shielding filter according to claim 4, wherein the microparticles are triangular tabular microparticles with an aspect ratio of from 1.0 to 1.5 or hexagonal tabular microparticles with an aspect ratio of from 4.0 to 7.0.

10. The infrared shielding filter according to claim 5, wherein the equivalent spherical diameter of the microparticles is from 5 to 30 nm.

11. The infrared shielding filter according to claim 7, wherein the dielectric constant of the binder is from 2 to 2.5.

12. The infrared shielding filter according to claim 7, wherein the binder is polyvinyl pyrrolidone.
